(19) United States
(12) Patent Application Publication
(10) Pub. No.: US 2003/0069072 A1
(43) Pub. Date: Apr. 10, 2003

(54) Electronic competition system and method as well as a server and program

(75) Inventor: Mamoru Miura, Yamagata (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/259,503

(22) Filed: Sep. 30, 2002

(30) Foreign Application Priority Data
Oct. 5, 2001 (JP) 2001-310264
Jun. 7, 2002 (JP) 2002-167326

(51) Int. Cl. A63F 13/00

(52) U.S. Cl. 463/42

(57) ABSTRACT

A competition site server is connected to a strike point detector and a personal computer by way of a LAN and includes a database management system for accumulating, converting to a database, and managing the competition progress and competition results of each competitor. A Web server that can connect to the Internet includes an integrative database management system for implementing centralized management of the competition progress and competition results of each competitor that is managed by the database management system of each competition site server in synchronization with the database management systems. The Web server publishes on the Internet the competition progress and competition results (for example, the track of bullet strike points) that are under the centralized management of the integrative database management system.

### Background OF THE INVENTION

1. Field of the Invention

The present invention relates to an electronic competition system for holding an electronic competition between a plurality of competitors, and more particularly to an electronic competition system for competing in a shooting competition in which a plurality of competitors compete for superiority by controlling a light-beam gun to direct and fire “light bullets” at targets instead of shooting with live ammunition and gain points according to the positions struck by the light bullets.

2. Description of the Related Art

Shooting has long been known as a sporting event. In a shooting competition, the use of a light-beam gun is to be desired over shooting with live ammunition using guns that shoot real bullets, which, from the standpoint of safety, must be conducted with special caution. Known light-beam guns include guns developed for use in competitions that employ flashlights and guns that are used for target practice in which a light-beam gun is directly wired to a computer for indicating striking of the “light bullets”.

When a computer and light-beam gun are directly connected by electrical wiring, however, this electrical wiring detracts from the highly sharpened senses of the contestants and interferes with their mental composure and concentration, and a means other than wires for connecting the light-beam gun and computer is therefore to be desired. Further, a system is also desired in which the accuracy of detection in the optical system of the strike point of the laser light of the light-beam gun constitutes the level of the competition, and in which the safety of the light-beam gun that shoots laser light is guaranteed. Finally, a system is also desired that, in addition to meeting these demands, obtains an improvement in the speed and accuracy of calculating competition scores.

We first refer to FIG. 1, in which is shown a schematic view of an electronic competition system of the prior art that uses light-beam guns. In this electronic competition system, a plurality of strike point detectors 2 are arranged corresponding to a plurality of shooting boxes that are each formed by a pair of partition plates 3. An example is shown in FIG. 1 in which the number of shooting boxes and strike point detectors 2 is five, but the number of these sets is not restricted. One shooting box and one strike point detector 2 have a one-to-one correspondence both in terms of position and for the competition, and as a rule, light bullets are not fired at a plurality of strike point detectors 2 from one shooting box. A square or circular target board 4 is secured to the front surface of each strike point detector 2.

Common plane 5 is formed by the front surface of each target board 4. Common shooting-permitted plane 6 is formed at the front surface of each of the shooting boxes. Common plane 5 and common shooting-permitted plane 6 are parallel, perpendicular planes. An example is shown in which the distance between common plane 5 and common shooting-permitted plane 6 is 10 meters or 25 meters depending on the category of competition. The horizontal width of shooting boxes along common shooting-permitted plane 6 is 1 meter when one gun is arranged for one target, but is variably stipulated when one gun is arranged for n targets. An example is shown in which the horizontal width of strike point detectors 2 is 30 cm and the distance between centerlines of two adjacent strike point detectors 2 is 1 m.

Strike point detectors 2 each emit cone-shaped beams 8 that are generated by infrared LEDs. Cone-shaped beams 8 each reach only as far as the shooting box that is directly opposite, and as a rule, do not reach two shooting boxes. Light bullets 34 that are fired from laser guns 7 have signals that correspond to specific laser guns 7. Laser bullets 34 arrive at target boards 4 as light points with high parallel luminous flux. Strike point detector 2 has a modulation capability for raising the electrical, mechanical, and optical accuracy of the position-detecting optical elements, and the accuracy of detecting the striking position of the laser beam can therefore be set as the competition level.

FIG. 2 is a block diagram showing the composition of an electronic competition system of the prior art. As shown in FIG. 2, this electronic competition system is provided with competitor's laser gun 7, target board 4, target board 4′, and competitor PC 66. Each competitor directs and fires a laser beam, i.e., a laser bullet 34, from laser gun 7 toward target board 4 and competes by scoring points that are added according to the position of each hit. Strike point detector 2, which includes target board 4 that corresponds to one competitor's laser gun 7, is connected to competitor PC 66.

Competitor PC 66 displays, either simultaneously or in time intervals: a competitors' identifying number, bullet numbers, the scores corresponding to the bullet numbers, the total score, and the strike position of light bullets 34 that have hit target board 4. By carrying out the process for calculating competition scores on competitor PC 66 or at strike point detector 2 in this electronic competition system, the calculations can be carried out both accurately and rapidly to allow for smooth management of the competition.

In addition, target board 4 at 10 m can be exchanged for target board 4′ at 25 m. Strike point detectors 2 transmit cone-shaped beams 8 toward the shooting boxes. The safety of the competition is guaranteed because the system is arranged such that light bullet 34 cannot be fired if the competitor does not receive cone-shaped beam 8 that is transmitted from strike point detector 2, i.e., if laser gun 7 in a shooting box is not directed toward target board 4. Since this signal, which is one of the sufficiency conditions that enable firing of light bullet 34, is generated on the target board 4 side in this electronic competition system, control is relegated to the target side rather than the gun side, and the competition system is therefore fair and defers to the judgment of the competition sponsors (judges). In addition, because laser guns 7 in this system need not send information other than light bullets 34 to the outside, laser guns 7 do not have to be connected to competitor PC 66.

Laser gun 7 fires a plurality of light bullets 34 for a single operation of the trigger. This provision not only enables averaging of the score of each light bullet 34, but also allows the score for each light bullet 34 to be found. In this method of calculating scores, differences in score can be given based on slight movements of the hand after pulling the trigger, factors such as movement of competitor's entire body can be expressed numerically, and new competition modes can be offered that were not available in single-shot shooting with real bullets.

Light bullets 34 each include a strike point detection signal that is used for detecting the strike point and a light-bullet discrimination signal for distinguishing a light bullet from other light bullets. The strike point detection signal is transmitted to target board 4 even when the trigger of laser gun 7 is not pulled, and the strike point can therefore be detected by strike point detector 2. In this way, the strike points of a plurality of light bullets 34 can be tracked as a continuous series of points.

When shooting with real bullets, a competitor first checks the feel of the gun before beginning to compete, and while competing, takes test shots at a target other than the object of scoring before actually shooting at the object of scoring. For this reason, a test shooting mode and an actual shooting mode are provided as operating modes in the electronic competition system. During a preparation period before starting the competition, competitors first check the feel of laser guns 7 in a state in which light bullets 34 are not fired. After the competition begins, competitors switch to the test-shooting mode to take test shots at a target other than the object of scoring, and, after completing test shooting, switch to the actual shooting mode to actually shoot at the object of scoring.

As described in the foregoing explanation, it is now becoming possible to realize an electronic competition system that is highly applicable to competition modes and that is safer than shooting with actual bullets. Owing to these advantages, it is expected that the number of people using such electronic competition systems as a typical competition will grow dramatically, and it can be expected that the use of such electronic competition systems will increase to the point that large-scale tournaments will be held on a national or international scale. At the present time, however, neither a design for training competitors nor the infrastructure for an electronic competition system that can accommodate a large-scale tournament has yet been constructed.

### SUMMARY OF THE INVENTION

It is an object of the present invention to provide an electronic competition system that is demonstrably effective in training competitors and that can be applied to a large-scale tournament.

To solve the above-described problems, the present invention an electronic competition system for holding an electronic competition in which a plurality of competitors compete is further provided with a server having a database management system that is connected by way of a communication network to an electronic competition means for outputting the competition progress or competition results of each of the competitors, this database management system successively accumulating, converting to a database, and managing the competition progress or competition results of each of the competitors.

In the electronic competition system of the present invention, the provision of a server having a database management system for accumulating, converting to a database, and managing the competition progress or competition results of each of the competitors enables the automatic accumulation of the competition progress and competition results of the competitors, and therefore can be applied to a large-scale tournament. This server further records the competition results of each competitor in the database management system. The adoption of this form allows each competitor to aim at raising his or her own competition level based on the recorded competition results and therefore has the effect of training competitors.

According to another electronic competition system of the present invention, the server publishes the competition progress or competition results that are managed by the database management system on the communication network. The adoption of this form allows checking of the data such as competition results that are managed by the database management system.

In another electronic competition system of the present invention, the server manages entrance registration for each of the competitors, publishes information regarding each competitor that has performed entrance registration on the communication network, carries out scheduling for each of the competitors, and manages the competition progress of each competitor.

In another electronic competition system of the present invention, the server singles out finalists from among the competitors based on the competition results that are managed by the database management system and publishes information on each of the finalists on the communication network. The adoption of this form enables the automatic execution of the processing that is necessary for the progress of a tournament and therefore enables smoother administration of a tournament. The information on each of the finalists preferably includes a picture of the finalist.

In another electronic competition system of the present invention, the electronic competition means is provided with a plurality of sets that each include:

a light gun for shooting light bullets;

a strike point detection means for detecting the strike point when a light bullet that has been fired from the light gun hits a target; and

a competitor computer that is provided in the vicinity of the shooting box for shooting the light gun, that is connected to the strike point detection means by way of a communication network, and that is used by the competitors for proceeding with the competition;

the electronic competition means being a means for adding scores based on the strike points of light bullets when the light bullets are directed and fired at the targets by operation of the light guns.

In another electronic competition system of the present invention, the competitor computer includes a database client that can access data of the database management system.

In another electronic competition system of the present invention, a competitor can check the competition progress and competition results that are managed by the database management system during a competition.

In another electronic competition system of the present invention, the competitor computer displays competition modes based on control by the server and displays time relating to the competition based on control by the server. Adopting this form allows smoother administration of a competition.

In another electronic competition system of the present invention, the competitor computer is provided with a camera for acquiring images of competitors. In addition, the strike point detection means is provided with a camera for acquiring images of competitors.

Adoption of this form allows the appearance and expressions of competitors to be captured during competition, thereby enabling an improvement of the service provided to the audience.

In another electronic competition system of the present invention, the competitor computer is provided with an identification information input means for receiving as input identification information of each of the competitors, and the server is provided with approval means for collating the identification information that has been received from competitor computers and identification information of competitors that have registered in advance and, when the information matches, for approving the identity of the person that has entered the identification information to the identification information input means. Adoption of this form can prevent another person from competing in a competitor's place and can improve the fairness of the competition.

In another electronic competition system of the present invention, the competitor's computer and the strike point detection means are adjusted according to the competition level. Adoption of this form allows adjustment according to the competition level of a competitor and allows a competition to proceed smoothly.

In another electronic competition system of the present invention, a second server is provided that can connect by way of the Internet to each of the servers that are established at each of a plurality of competition sites and that includes an integrative database management system that, in synchronism with the database management systems, performs centralized management of the competition progress and competition results of each competitor that are managed by the database management systems of each of the servers. In the electronic competition system of this invention, the provision of the integrative database management system allows the competition progress and competition results of all competitors to be automatically accumulated even when a tournament is a large-scale event that is held at a plurality of shooting sites that are distributed in different locations, thereby enabling smoother management of a tournament.

In another electronic competition system of the present invention, the second server publishes on the Internet the competition progress or competition results that are under the centralized control of the integrative database management system. Adoption of this form allows checking of data such as competition results that are managed by the database management systems.

In another electronic competition system of the present invention, the second server publishes a Web page on the Internet for entrance registration and manages the entrance registration of each competitor, that has used the Web page to carry out entrance registration. Since contestants can be registered automatically on the Web page, the adoption of this form can reduce the burden placed on competitors and competition sponsors.

In another electronic competition system of the present invention, the second server publishes on the Internet information on each competitor that has carried out the entrance registration. Adoption of this form can promote widespread general interest in a tournament. Further, in another electronic competition system of the present invention, the second server collects fees from each competitor that has registered as an entrant. Adoption of this form decreases the burden on the competitors and competition sponsors involved in collecting competitors' fees.

In another electronic competition system of the present invention, the second server singles out finalists from among the competitors based on the competition results that are managed by the integrative database management system and publishes information on each of the finalists on the Internet. Adoption of this form allows the finalists to be checked at the servers of each competition site and allows the subsequent final rounds to proceed smoothly.

The information on each of the finalists preferably includes a picture of each of the finalists.

In another electronic competition system of the present invention, a display means is provided that can simultaneously display the competition progress of a plurality of competitors or the competition results of a plurality of competitors.

By adopting this form, display means may be established both in and outside competition sites and the state of the competition can be conveyed to an unspecified multiplicity of viewers, whereby a tournament can be further promoted.

The competition progress and competition results include the track of the strike points.

The track of strike points is information that is not stored when shooting with actual bullets, and taking this information as one type of competition result allows the introduction of a new competition mode to a shooting competition. In addition, since the track of strike points is important information for training a competitor, the management of this information in a database will be effective in training competitors.

In addition, delivering an announcement that a competition is to be held to predetermined transmission destinations can not only recruit a large number of potential contestants, but, if the announcement that a competition is to be held includes information for accessing a site that posts information relating to the competition, potential contestants can easily access the site that posts information relating to the competition.

As described in the foregoing explanation, the electronic competition system of the present invention has the following merits:

1) The provision of a competition site server enables the automatic accumulation of competition progress and competition results and therefore allows application to large-scale tournaments.

2) The competition site server records the competition results of each competitor in a database. Adoption of this form allows each competitor to endeavor to raise his or her competition level based on the competition progress and competition results that have been recorded and therefore is effective in training competitors.

3) The provision of a Web server that includes an integrative database management system by way of the Internet allows a tournament to be held that uses a plurality of shooting sites that are distributed in various locations and eliminates the need for all competitors to assemble at a single site, thereby easing the burden on both competitors and tournament sponsors.

4) The provision of a Web server that includes an integrative database management system by way of the Internet enables the automatic accumulation of the competition progress and competition results of all competitors if a tournament is a large-scale even that is held at a plurality of shooting sites that are distributed over several locations and therefore enables the smooth management of a tournament.

5) Since the competition progress and competition results of each competitor are published on the Internet, each competitor can access the Web server by way of the Internet and then seek to raise his or her competition level based on the competition results that are managed by the integrative database management system of the Web server, and the system therefore has the effect of training competitors.

6) The use of the Internet allows a reduction of the cost for building a system infrastructure.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a schematic view showing an electronic competition system of the prior art that uses a light-beam gun.

FIG. 2 is a block diagram showing the composition of an electronic competition system of the prior art.

FIG. 3 is a block diagram showing the composition of an electronic competition system of the first embodiment of the present invention.

FIG. 4 is a block diagram showing the composition of an electronic competition system of the second embodiment of the present invention.

FIG. 5 is a sequence chart showing the operation of the electronic competition system of the second embodiment of the present invention.

FIG. 6 is a sequence chart showing the operation of the electronic competition system of the second embodiment of the present invention.

FIG. 7 is a sequence chart showing the operation of the electronic competition system of the second embodiment of the present invention.

FIG. 8 is a flow chart for explaining the operation of the process for pre-registration of an entrant at a Web server of the electronic competition system shown in FIG. 4.

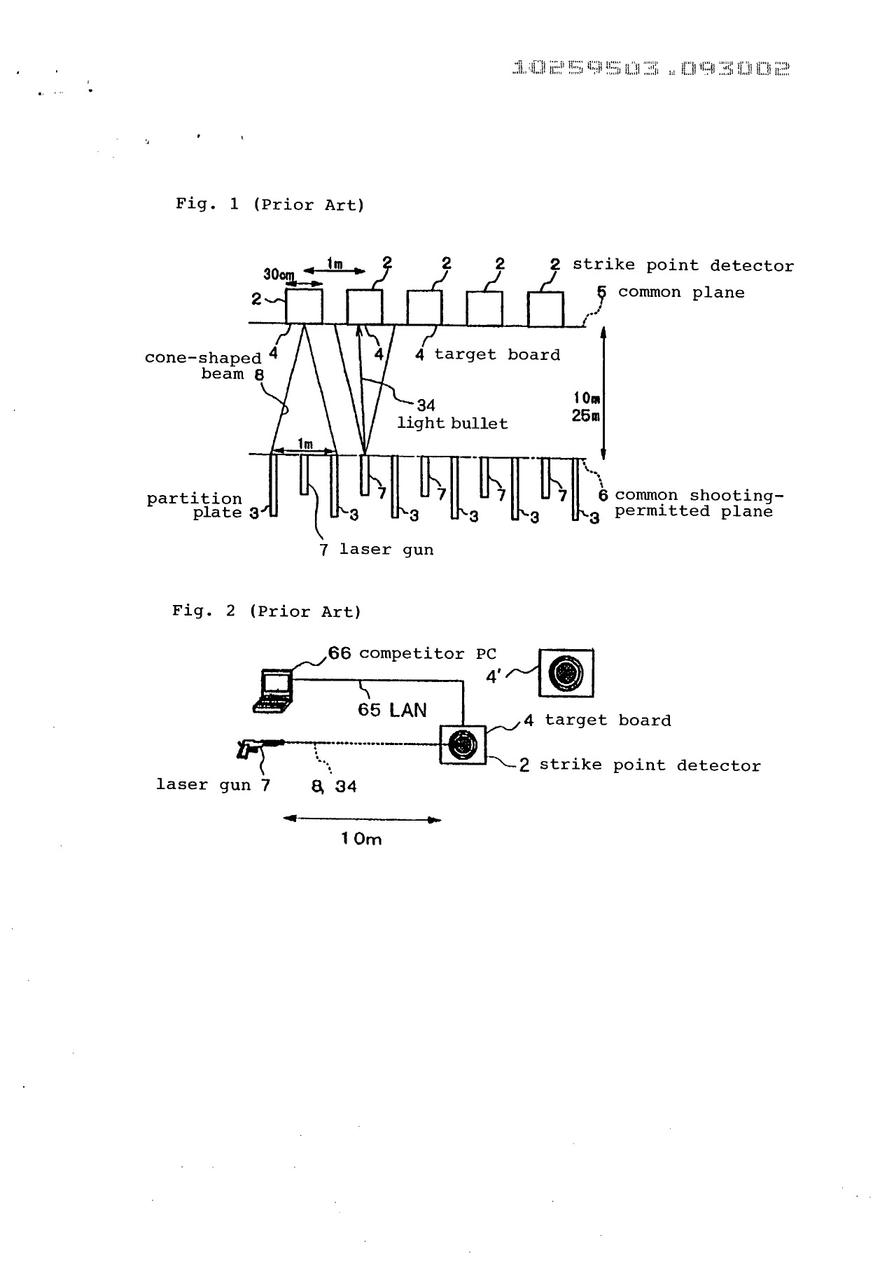

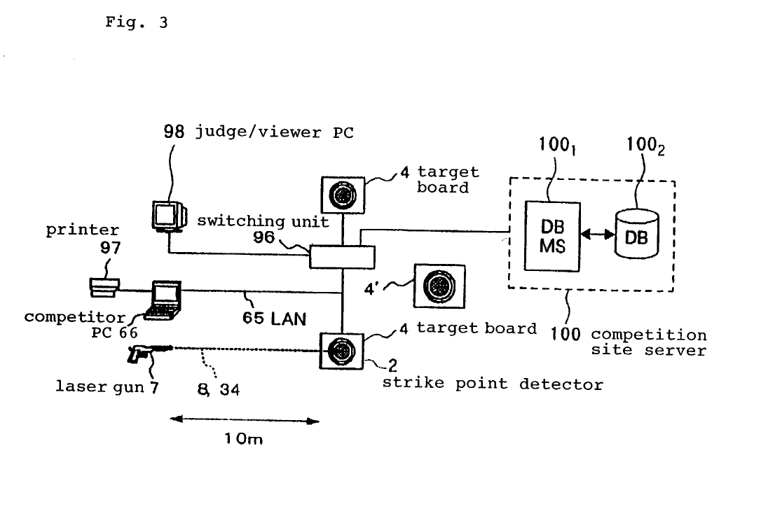

### DETAILED DESCRIPTION OF THE PREFERRED EMBODIMENTS

We next refer to the accompanying drawings to explain the details of embodiments of the electronic competition system of the present invention. In all the figures, constituent elements having the same reference numeral are identical.

First Embodiment

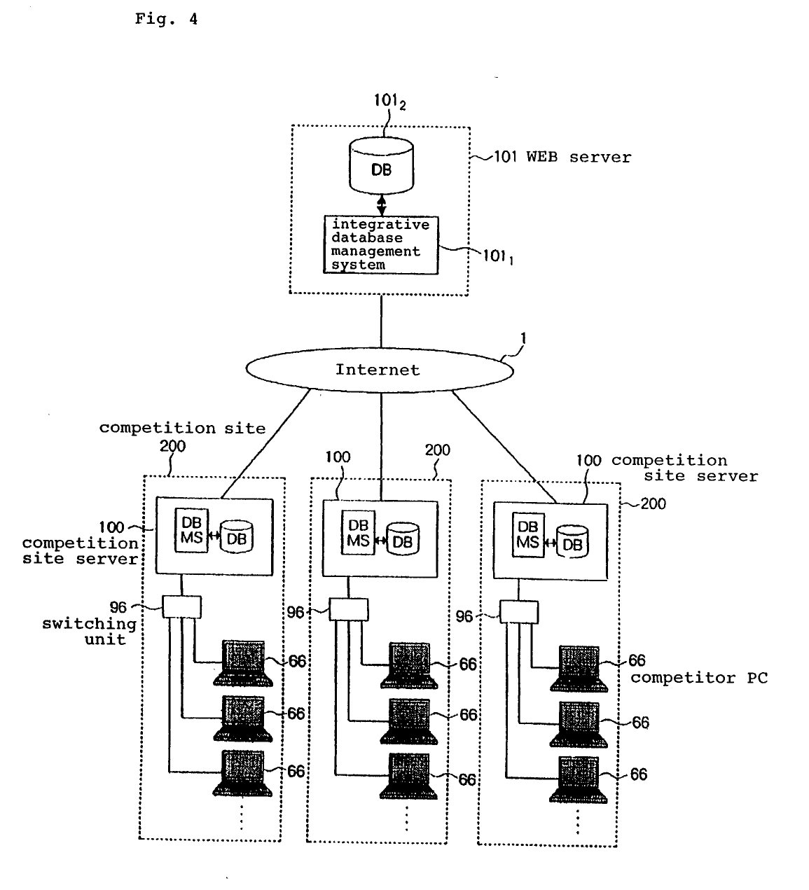

First, regarding the electronic competition system according to the first embodiment of the present invention, we refer to FIG. 3, which is a block diagram showing the composition of the electronic competition system of this embodiment. As shown in FIG. 3, the electronic competition system of this embodiment is provided with: laser gun 7, target board 4, target board 4′, LAN 65, competitor PC 66, switching unit 96, printer 97, judge/viewer PC 98, and competition site server 100. Each competitor directs and shoots a laser beam, i.e., light bullet 34, from laser gun 7 toward target board 4 and competes for superiority by scoring points that are calculated according to the positions hit by the laser beam. Both strike point detector 2 that includes target board 4 that corresponds to laser gun 7 of one competitor and strike point detector 2 that includes target board 4 that corresponds to laser gun 7 of another competitor are connected by way of LAN 65 such as a 10 BASE-T to competitor PC 66 that is established in the vicinity of the competitors that handle laser guns 7. Switching unit 96 is a switching hub of LAN 65. Judge/viewer PC 98 is also connected to switching unit 96.

A competitor's sequence number, bullet numbers, the scores that correspond to the bullet numbers, the total score, and the points that are hit when light bullets strike target board 4 are displayed on competitor PC 66, either simultaneously or sequentially. In this electronic competition system, the competition score calculation process is carried out at competitor PC 66 or at strike point detector 2, and this calculation can therefore be performed both accurately and quickly to smooth the operation of the competition.

The final tabulation of competitor results is outputted from printer 97, which is connected to competitor PC 66. Judges and viewers can use judge/viewer PC 98 to check competitors' results such as the competitors' sequence numbers, bullet numbers, the scores corresponding to the bullet numbers, the total scores, and the points that are hit when light bullets strike target board 4. Ten-meter target board 4 can be exchanged for 25-meter target board 4′. Strike point detector 2 transmits cone-shaped beam 8 toward the shooting box. The safety of the competition is guaranteed because the system is arranged such that a competitor cannot shoot light bullet 34 unless he or she receives cone-shaped beam 8 that is transmitted from strike point detector 2, i.e., unless laser gun 7 in a shooting box is directed at target board 4. In this electronic competition system, the signal that is one of the sufficiency conditions that enables shooting of light bullets 34 is generated at target board 4, meaning that the initiative lies on the target board 4 side and not on the gun side. This competition system therefore contributes to fairness and defers to the judgment of the competition sponsors (judges). In this system, moreover, laser guns 7 need not transmit information to the outside other than light bullets 34 and therefore need not be connected to competitor PC 66 by wires.

In the electronic competition system of the present embodiment, the strike points of a plurality of light bullets 34 can be converted to a track as a series of continuous points. This track is displayed on competitor PC 66 and judge/viewer PC 98 or on a competition screen at the site. The size of the area of this track, the average distance of separation from the origin bull's eye, and the angular distribution around the origin can strictly and variously represent the relative movement of the gun barrel of laser gun 7. This conversion to a track could not be expressed in competition with live ammunition of the prior art. Finding the fluctuation wavering in this track allows, for example, a competitor to correct operation of the trigger of laser gun 7.

Competition site server 100 is connected to LAN 65 by way of switching unit 96. Competition site server 100 further includes database management system (DBMS) 1001 that is connected to strike point detector 2 and competitor PC 66 by way of LAN 65 and that accumulates, converts to a database, and manages the competition progress and competition results of each competitor. Each competitor PC 66 successively uploads the competition progress and competition results such as the score and track data of each competitor to competition site server 100. Database management system 1001 is a manager system that both manages the various collected data in database 1002 and operates such that users that access database 1002 can always conveniently use data. A database management system such as one offered by Oracle is typically used as database management system 100₁. Each competitor PC 66 has a database client function that can access the data of database management system 100₁, and competitors can thus use each competitor PC 66 during a competition to check (for example, review competition results) the competition progress and competition results that are managed by database management system 100₁. In addition, each competitor, judge, and viewer at a competition site can use a terminal (such as a personal computer, portable telephone, or PDA) that can connect to LAN 65, which is a communication network, to access competition site server 100 and thereby check data such as the competition results that are managed by database management system 100₁. The competition progress and competition results include: contest results, the standing of a competitor at the current time (real time rank), the current state of a competitor's target, the current state of hits (point average, strike locations, and graphs for analyzing this information), and each competitor's score, hit positions, and track (trace). In addition, information such as a competitor's past record may also be combined and displayed with the competition progress.

Competition site server 100 singles out finalists from all competitors based on each competitor's competition progress and competition results that are managed by database management system 100₁ and publishes information on each of the finalists on LAN 65. The information on the finalists includes pictures of the finalists, names, experience, competition progress, and competition results (such as a reproduction of all shooting tracks) up to the present. In addition, the pictures may be taken by a camera that is provided at competitor PC 66, strike point detector 2, or competition site server 100.

The use of a terminal that can connect to LAN 65 at the competition site allows viewing of information on finalists that has been published at competition site server 100, and based on this information on the finalists, the finalists' competition schedule can be arranged and the progress in the competition of each of the finalists can be managed at competition site server 100.

<Merits>

In the electronic competition system of the present embodiment, the provision of competition site server 100 allows the automatic accumulation of competition progress and competition results and therefore allows applications for a large-scale tournament. Further, competition site server 100 records the competition progress and competition results of each competitor in database management system 100₁, and each competitor is therefore able to check his or her own competition progress and competition results. By adopting this form, each competitor is able to aim at raising his or her level of competition based on the recorded competition progress and competition results, and the electronic competition system of the present embodiment therefore has the effect of enabling training of competitors.

Competition site server 100 further performs the overall management of a competition. Competition site server 100 first manages the entrance registration of competitors, including for example the registration of contestants and alteration of the registration content on the day of the tournament. The information regarding each of the competitors that have registered as contestants is published on LAN 65 by competition site server 100. Competition site server 100 then performs scheduling, such as the order of competition of each of the competitors that have registered as contestants under the management of competition site server 100. The scheduling data that have been prepared by competition site server 100 is, for example, printed by printer 97, or made viewable on a terminal that can connect to previously described LAN 65. Competitor server 100 further manages the progress of the competition of each of the competitors at the competition site. Competition site server 100 controls competitor server 66 by way of LAN 65 and causes display of the competition modes such as the previously described preparation period, test firing, and actual firing modes as well as display of, for example, the remaining time. The present embodiment thus enables smooth management of a large-scale tournament.

Competitor PC 66 and strike point detector 2 are preferably adjusted according to the competition level. Adoption of this form allows the resolution of strike point detector 2 to be raised in the final rounds, allows the competition level to be adjusted to a level that is suitable for competitors that have advanced to the final rounds, and allows efficient progression of the final rounds of the competition.

Competitor PC 66 may be further provided with an identification information input means (not shown in the figures) for entering identification information of each of the competitors, and competition site server 100 may be provided with an approval means (not shown in the figures) for approving the identity of competitors based on the identification information. The identification information is information for identifying whether or not a person is in fact a competitor and may take the form of a password that has been conferred in advance to each competitor or fingerprints of the competitors.

The competitors use the identification information input means of competitor PC 66 to enter information before the start of the competition, whereupon this identification information is transmitted to competition site server 100 by way of LAN 65. The approval means of competition site server 100: collates identification information that has been entered from competitor PC 66 with identification information of competitors that has been registered beforehand, for example, when a competitor carried out entrance registration; determines whether or not the competitor is the correct person; and upon determining that the identity is correct, approves the identity of the person that has entered the identification information to the identification information input means. Adoption of this form prevents a person other than an approved person to compete and can guarantee the fairness of the competition.

In addition, a program for executing the operation of competition site server 100 is recorded in competition site server 100. This program is a constituent element for controlling the operation of the hardware of competition site server 100, which is a computer server, and all of the processing of the above-described competition site server 100 is designated by this program.

Second Embodiment

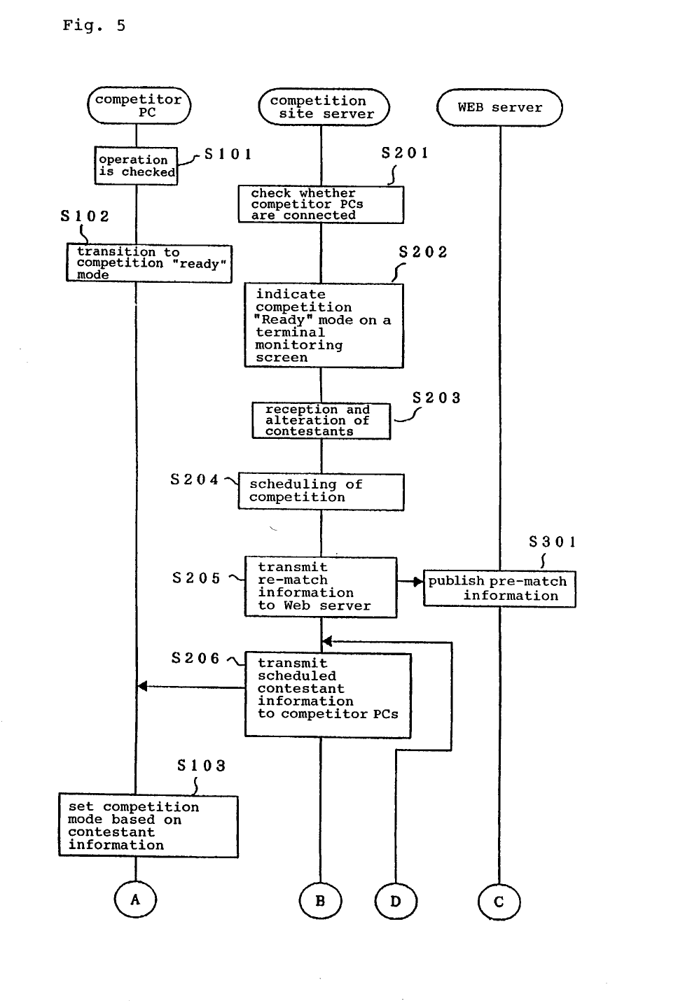

Explanation next regards the electronic competition system of the second embodiment of the present invention. FIG. 4 is a block diagram showing the composition of the electronic competition system of the present embodiment. The electronic competition system of the present embodiment is a system that is particularly effective when the tournament is a large-scale even such as a national or international tournament. In the electronic competition system of the present embodiment, an electronic competition system of the first embodiment is constructed and competition site servers 100 are established at each competition site 200, and competition site server 100 of each competition site 200 can connect to Internet 1. The electronic competition system of the present embodiment is further provided with Web server 101 that can connect to Internet 1. Web Server 101 includes integrative database management system 101₁ that, in synchronization with database management systems 100₁, implements centralized control of the competition progress and competition results of each competitor that are managed by database management systems (DBMS) 100₁ of each competition site server 100. As an example, a typical system offered by Oracle can be used as integrative database management system 101₁ to realize this type of data synchronization.

In addition, Web server 101 can publish the competition progress and competition results that are under the centralized control of this integrative database management system 101₁ on Internet 1. For example, an individual that can access Internet 1 can, by accessing Web server 101, immediately view each competitor's scores that are updated from minute to minute.

Each competition site server 100 and Web server 101 are assigned a global IP address for connecting to Internet 1, and, since competition progress and competition results that have been collected and managed by integrative database management system 101₁ must be converted to data that are publishable on the Web in order to publish these data on Internet 1, Web server 101 and terminal must obviously be capable of handling functions such as FLASH and JAVA.

Finally, Web server 101 singles out finalists from all of the competitors based on competition progress and competition results that have been collected and managed by integrative database management system 101₁ and publishes information on each finalist on Internet 1. Information on each finalist that has been published can be viewed at each competition site 200 by way of competition site servers 100, and, when finalists are present at a competition site 200, competition scheduling for the finalists is carried out and the progress of the competition for each finalist is managed at competition site servers 100 based on this information on each finalist.

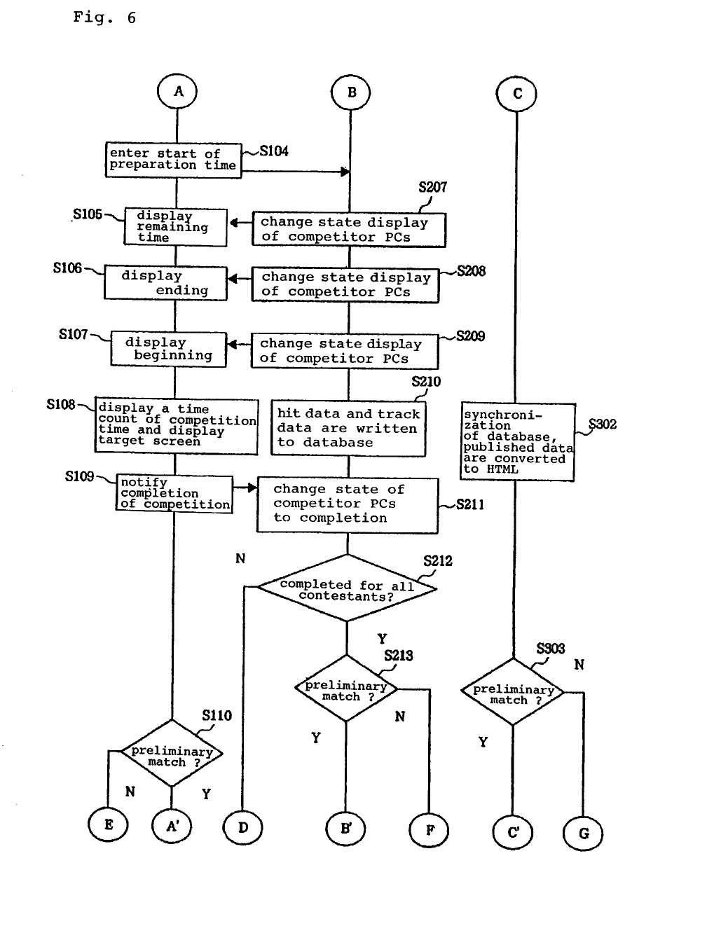

FIGS. 5, 6, and 7 are sequence charts showing the operation of the electronic competition system of the present embodiment. As shown in FIG. 5, operation is first checked at competitor PCs 66 (Step S101). Competition site servers 100 then check whether competition site servers 100 are connected to all competitor PCs (Step S201). This connection check is preferably carried out by polling access from all competitor PCs 66. When there are competitor PCs 66 that require new registration, an assignment wizard is activated and the new registration is carried out. At this time, the assigned number of each competitor PC 66 should be identical to the shooting box number of that competitor PC 66.

Each competitor PC 66 then makes the transition to the competition “ready” mode (Step S102). At this time, each screen of competitor PCs 66 preferably indicates the competition “Ready” mode by means of a message such as “In Preparation.” At this time, competition site servers 100 indicate on a terminal monitoring screen that the competitor PCs are in the competition “Ready” mode (Step S202).

After carrying out the reception and alteration of contestants (Step S203), competition site servers 100 perform scheduling of the competition (Step S204). The scheduling data are printed out by, for example, printers 97, and distributed among the competitors, judges, and viewers that are present at the sites. The scheduling data include the shooting boxes at which the competition takes place, the starting time of the competition, and information regarding the site and its vicinity. After the time in which alterations of scheduling are allowed has passed, competition site servers 100 transmit the scheduling data to Web server 101 as the pre-match information (Step S205), and Web server 101 publishes the pre-match information on Internet 1 (Step S301).

Based on the scheduling data, competition site servers 100 transmit contestant information regarding the contestants that are to use shooting boxes to competitor PCs 66 that are established in the shooting boxes (Step S206). When the contestant information has been transmitted, competitor PCs 66 set the competition mode (Step S103). Competitor PCs 66, competition site servers 100, and Web server 101 then proceed to A, B, and C, respectively, of FIG. 6.

As shown in FIG. 6, the competitors then proceed to the shooting boxes in which they will compete based on the distributed scheduling data and enter the start of preparation time as input to competitor PCs 66 (Step S104). This input of the start of the preparation time is transmitted to competition site servers 100, and competition site servers 100 command a change of the state display to competitor PCs 66 (Step S207) and cause competitor PCs 66 to display the time that remains of the preparation time (Step S105). When the preparation time has ended, competition site servers 100 command competitor PCs 66 to change the state display (Step S208), and competitor PCs 66 display an indication that the preparation time has ended (Step S106).

When it is time for the start of competition, competition site servers 100 command competitor PCs 66 to change the state display (Step S209), and competitor PCs 66 display an indication that competition has begun (Step S107). Competitor PCs 66 display a time count of the competition time and display the target screen (Step S108). The competitors then take part in the shooting competition in this state, and the competition progress and hit data and track data, i.e., the competition results, are written by database management systems 100, of competition site servers 100 to database 100₂ by way of strike point detector 2 as necessary (Step S210). At integrative database management system 101₁ of Web server 101, data synchronization has been established with database management systems 100₁ of competition site servers 100 at this time, and when the data of databases 100₂ are updated, the data of database 101₂ of Web server 101 are similarly updated (Step S302).

In Web server 101, a Web site is published on Internet 1 by means of data that are registered in database 101₂ (Step S302). In this way, the competition progress and competition results at competition sites 200 can be viewed at terminals (not shown in the figure) that can connect to Internet 1 by simply accessing the Web site created by Web server 101. In addition, the competition progress and competition results include not only the match results, the ranking (real time ranking) of the competitors at the current time, the current state of the targets of each competitor, and the state of hits (average score, location of hits, and graphs for analyzing these data) up to the present time, but also include the scores of each competitor, and the hit points and their tracks (traces). In addition, information such as the past records of competitors may also be shown together with the competition progress.

Upon completing the competition, the competitors enter the competition completion to competitor PCs 66, whereupon competitor PCs 66 notify the completion of competition to competition site servers 100 (Step S109). Competition site servers 100 change the state of competitor PCs 66 to completion (Step S211).

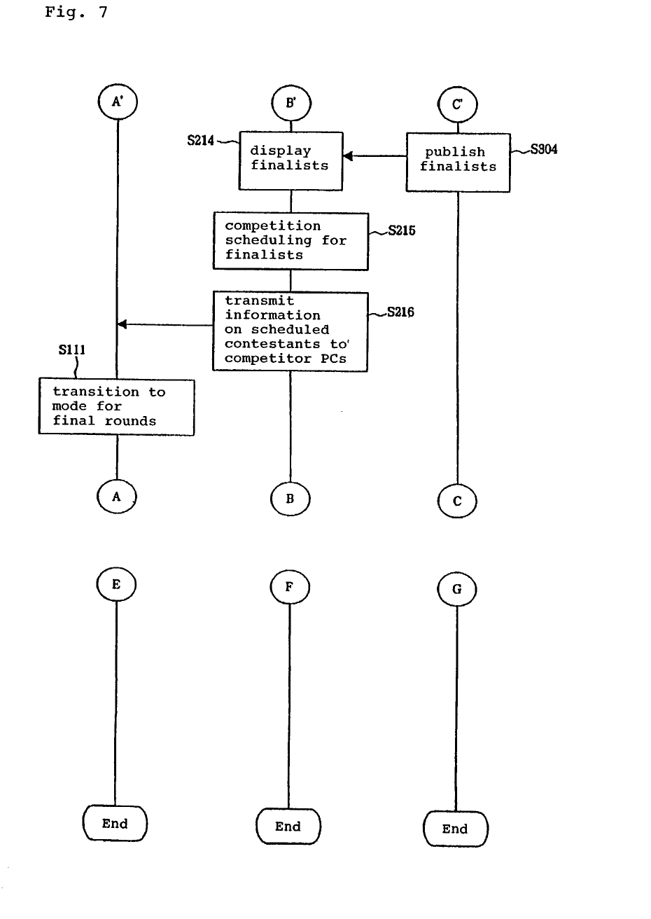

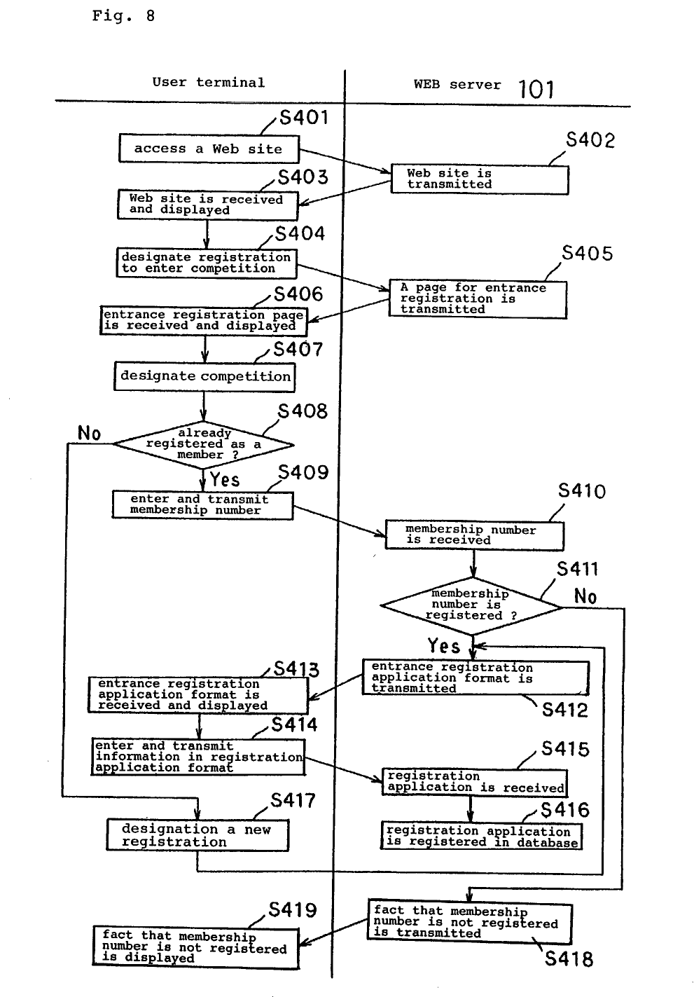

If competition has not been completed for all contestants in Step S212, competition site servers 100 proceed to “D,” and competitor PCs 66, competition site servers 100, and Web server 101 carry out the operations starting from Step S206 for the next competitor. If competition is completed for all contestants in Step S212, and if the competition is a preliminary match in Steps S110, S213, and S303, competitor PCs 66, competition site servers 100, and Web server 101 proceed to A′, B′ and C′, respectively, in FIG. 7 [NOTE: “FIG. 4” in the J-text.].

As shown in FIG. 7, Web server 101 singles out the finalists from among all contestants based on the competition results of all contestants and publishes the finalists on Internet 1 (Step S304). Competition site servers 100 display the published finalists on browsers (Step S214), carry out the competition scheduling for the finalists that are at that site (Step S215), and transmit information on the contestants that have been scheduled to competitor PCs 66 (Step S216). Competitor PCs 66 then make the transition to the mode for the final rounds (Step S111) and competitor PCs 66, competition site servers 100, and Web server 101 return to A, B, and C, respectively, of FIG. 6. When competitor PCs 66 make the mode transition for the final rounds, the competition environment may be set to a state that is appropriate for the final rounds; for example, the positional detectors of target board 4 may be set to a higher resolution than in the preliminary competition. Further, when finalists are present at a particular competition site 200, the relevant competition site server 100 can post data such as the names, past records, or pictures of the finalists that have been taken by a camera that has been provided in a competitor PC or by the cameras of competition site 200.

Subsequently, when all contestants have finished in Step S212 and if the competition is not a preliminary competition, competitor PCs 66, competition site servers 100, and Web server 101 in Step S110, S213, and S303, respectively, proceed to E, F, and G in FIG. 6, thereby completing the process. In addition, the data that are managed by database management systems 100₁ of competition site servers 100 are preferably deleted after the entire competition has been completed.

At Web server 101, the competition results at each competition site 200 are accumulated after the competition has been completed, and the Web site on which the accumulated results are posted is published on Internet 1. For example, data such as the year's competition ranking are accumulated and published on Internet 1. In the competition results for each competition site 200, information such as competition categories, total competition scores, detailed scores, competition standings, and competition modes is placed in correspondence with information such as competitors' names or membership numbers that can distinguish competitors. These accumulated results are registered in database 101₂ of Web server 101, and the Web site can therefore be used to search past data.

<Pre-Registration>

In the electronic competition system of the present embodiment, the registration of contestants before holding the tournament can be carried out at Web server 101. First, the essential points regarding holding the tournament are posted at Web server 101, and a Web page for registering contestants is published on Internet 1 for a prescribed period. Individuals wishing to take part in the event access the Web page by way of Internet 1 and register as contestants. Information regarding contestants who have registered is managed as contestant information in integrative database management system 101₁. Contestant information may still be modified even after having once been registered, and registration can be canceled or registration content can be altered by way of the Web page up to a prescribed fixed day.

Explanation next regards the pre-registration process at Web server 101 such as described in the foregoing explanation.

We first refer to FIG. 8, in which is shown a flow chart for explaining the pre-registration process at Web server 101 of the electronic competition system shown in FIG. 4. In this example, a case is explained in which a user terminal (not shown in the figure) that can connect to Internet 1 shown in FIG. 4 is used to submit a pre-registration application.

First, an individual wishing to participate in a competition that is batch-managed by Web server 101 uses a user terminal that can connect to Internet 1 to access a Web site that is managed by Web Server 101 (Step S401).

The Web site is then transmitted from Web server 101 (Step S402), received by the user terminal by way of Internet 1, and displayed on the screen of the user terminal (Step S403). The Web site that has been transmitted from Web server 101 and displayed on the screen of the user terminal posts information relating to a competition that is batch-managed by Web server 101 and within this information an area is included for designating registration to take part in the competition.

When an individual who wishes to enter the competition designates the intention to carry out registration to enter the competition (Step S404), a page for carrying out entrance registration for the competition is transmitted from Web server 101 (Step S405).

The entrance registration page that has been transmitted from Web server 101 is received by the user terminal by way of Internet 1 and displayed on the screen of the user terminal (Step S406). The entrance registration page that is transmitted from Web server 101 and displayed on the screen of the user terminal includes an area for designating the competition for which registration is being carried out and an area for entering the membership number if the applicant has already registered as a member.

An individual who wishes to participate in a competition designates the competition for which he or she is registering (Step S407), and if he or she has already registered as a member (Step S408), enters his or her membership number and transmits the membership number (Step S409).

When the membership number that has been transmitted from the user terminal is received at Web server 101 (Step S410), database 1012 is referenced to determine whether or not the received membership number is registered (Step S411). If the received membership number is registered, of the information that is registered in database 101₂ that corresponds with the membership number, the information that is necessary for registering to participate in the competition that was designated in Step S407 is recorded, and the registration application format in which the competition that was designated in Step S407 is recorded is transmitted from Web server 101 (Step S412), received by the user terminal, and displayed on the screen (Step S413). In addition to the personal information such as the name, nationality, affiliation, address, telephone number of a member that has registered as a member, the past competition record of the member is also registered in database 101₂ in correspondence with the membership number. In Web server 101, however, only the information that is necessary for registering as a participant in the competition that was designated in Step S407 is extracted from this information and recorded in the registration application format.

When the content that is recorded in the registration application format that is displayed on the screen of a user terminal is to be altered, the individual who wishes to participate in a competition makes the alteration and enters the information, or enters information for items that are not recorded in the registration application format, and transmits this registration application format to Web server 101 (Step S414).

When the registration application format that has been transmitted from the user terminal is received at Web server 101 (Step S415), the information that is recorded in the received registration application format is registered in database 101₂ as registration information for the competition that was designated in Step S407 (Step S416). In addition, the information relating to the member that is registered in correspondence with the membership number in database 101₂ is modified as appropriate based on information that is recorded in the registration application format that was received in Step S415.

If an individual who wishes to take part in a competition has not yet registered as a member (Step S408), designating that a new registration is to be made (Step S417) on the competition registration page that is displayed on the screen of a user terminal causes a transition to the process in Step S412, and the registration application format for entering information that is required for registering to take part in the competition that was designated in Step S407 is transmitted from Web server 101. In this case, moreover, although the competition that was designated in Step S407 is recorded in the registration application format that is transmitted from Web server 101, information relating to the person wishing to compete is not recorded.

The person wishing to take part in the competition enters, at the user terminal, the information that is required for registering to take part in the competition that was designated in Step S407 to the registration application format that has been transmitted in from Web server 101.

In addition, if the membership number that was applied as input in Step S409 is not registered, the fact that the membership number is not registered is reported to the user terminal from Web server 101 (Steps S418 and S419).

In this example, a case has been described in which an individual who wishes to take part in a competition uses a user terminal to freely access a Website that is managed by Web server 101. However, when a competition is to be held, it is also possible for Web server 101 to notify members who have registered as members that a competition is to be held by means of electronic mail, and the URL of the Web site may be pasted in this electronic mail.

Information that has been registered in advance by the above-described process is transmitted by way of Internet 1 from Web server 101 to competition site servers 100 before the competition is held and registered in the databases of competition site servers 100.

Carrying out pre-registration in this way enables a simplification of registration on the day of the competition.

Competition site server 100 transmits membership information that has been registered in the database to a site reception PC that is established at the reception of competition site 200 on the day of the competition.

Individuals wishing to take part in a competition must designate the competition that they wish to take part in and enter information relating to themselves by means of the site reception PC, but individuals wishing to take part who have already registered in advance by means of the above-described process can complete the site registration by simply entering their membership number at the site reception PC

When a membership number is received at a site reception PC, it is determined whether or not the membership number that has just been entered is included among the membership numbers that have been transmitted in from competition site server 100. If the entered membership number is included among the membership numbers that have been transmitted in from competition site server 100, the site registration is completed and information indicating that the site registration has been completed is added to the information that corresponds to the membership number. The input of the membership number can be performed with even greater reliability if the system is constituted such that the input of the membership number to the site reception PC is performed by reading the membership number from an ID card onto which the membership number has been written instead of having the participant enter the number.

In addition, when the information that corresponds to a membership number is to be modified, this intent can be entered at the site reception PC, and the information after modification then transmitted to competition site server 100, whereupon the database of competition site server 100 is updated.

To create more interest in a tournament, information regarding the participation of promising contestants that is within the range of publishable information of the contestant information that is managed by integrative database management system 101₁ may be published on a Web page as pre-tournament information.

Further, Web server 101 may also automatically collect the participation fees from contestants who have registered for an event (for example, by automatically withdrawing the fee from the contestants' accounts).

A program for executing the operations of Web server 101 is recorded in Web server 101. This program controls the operations of the hardware of Web server 101, which is a computer server, and the processes of the above-described Web server 101 are all designated by the program.

<Summary>

As described in the foregoing explanation, in the electronic competition system of the present embodiment, a Web server is provided that has an integrative database management system by way of Internet 1. Adoption of this form allows a tournament to be held using a plurality of shooting ranges that are distributed in various locations, whereby the need for competitors to assemble in a single location can be eliminated and the burden for both competitors and tournament sponsors can be eased. Further, even in the case of a large-scale tournament using a plurality of shooting ranges that are distributed in various locations, the competition progress and competition results of all competitors can be automatically accumulated to smooth the management of the tournament. Web server 100 records the competition results of each competitor in integrative database management system 101₁. Adoption of this form allows each competitor to access Web server 101 by way of Internet 1 and then aim at raising his or her level of competition based on competition results that are managed by integrative database management system 101₁ of Web server 101, and the invention therefore has the effect of training competitors. Further, the electronic competition system of the present embodiment takes advantage of Internet 1 to enable a reduction in the expense of building system infrastructure.

<Other Capabilities for Supporting Competitions>

The electronic competition system of the present embodiment can offer a variety of capabilities for supporting competition in addition to the above-described functions. For example, in addition to judge/viewer PC 98 of the competition site shown in FIG. 3, a large display screen using, for example, a video projector, can be installed at a competition site or other site, and this display screen can be used to simultaneously display the competition progress and competition results of a plurality of contestants including contestants at another competition site and thereby allow a large number of viewers and competitors to simultaneously follow the course of a competition. For example, the progress of a tournament that is being held at competition sites in Osaka and Sapporo can be shown on a large screen at the Tokyo National Stadium.

This type of display screen is preferably connected to LAN 65 and the display content is preferably controlled by competition site server 100 when established at a competition site, and may preferably be connected to Internet 1 and the display content controlled by Web server 101 when established at another site.

Because live ammunition is not used in the electronic competition system of the present embodiment, cameras that can capture the appearance or expression of competitors may be established in the vicinity of target board 4, and the expressions of the competitors may be captured during competition. By adopting of this form, competitors can be projected on the previously described display screens during competition and viewers can enjoy a front-row vantage point of the competition. In this case, a plurality of competitors can also be displayed at the same time. Further, the competition progress, competition results, and images of other competitors (including competitors at other competition sites) can also be shown on competitor PCs 66.

<Other Applications to Competitions>

The electronic competition system of the present invention can be applied to a variety of other competitions (including games). For example, the present invention is particularly suitable for competitions that employ an electronic system such as a TV game or a karaoke tournament that is held on a national scale. By applying the present invention to such a competition, the national standing of each competitor in each competition can be found instantly.

Finally, establishing shooting sites in which the electronic competition system of the present invention is applied as an amusement for families and generally popularizing electronic shooting games that are safe and that feature a variety of modes can both satisfy consumers' demand for entertainment and foster the development of a new game industry.

While preferred embodiments of the present invention have been described using specific terms, such description is for illustrative purposes only, and it is to be understood that changes and variations may be made without departing from the spirit or scope of the following claims.

What is claimed is:

1. An electronic competition system for holding an electronic competition in which a plurality of competitors compete, said electronic competition system being provided with:
a server having a database management system that is connected by way of a communication network to an electronic competition means for outputting competition progress and competition results of each of said competitors, said database management system successively accumulating, converting to a database, and managing each of said competition progress and competition results.

2. An electronic competition system according to claim 1, wherein said server publishes on said communication network competition progress and competition results that are managed by said database management system.

3. An electronic competition system according to claim 1, wherein said server manages entrance registration of each of said competitors.

4. An electronic competition system according to claim 2, wherein said server manages entrance registration of each of said competitors.

5. An electronic competition system according to claim 3, wherein said server publishes on said communication network information on each competitor that has carried out said entrance registration.

6. An electronic competition system according to claim 1, wherein said server carries out scheduling of each of said competitors.

7. An electronic competition system according to claim 1, wherein said server manages the competition progress of each of said competitors.

8. An electronic competition system according to claim 1, wherein said server singles out finalists from among said competitors based on competition results that are managed by said database management system.

9. An electronic competition system according to claim 8, wherein said server publishes on said communication network information on each of said finalists.

10. An electronic competition system according to claim 9, wherein said information on each of said finalists includes pictures of said finalists.

11. An electronic competition system according to claim 1, wherein said electronic competition means is provided with a plurality of sets of:
a light gun for shooting light bullets;
a strike point detection means for detecting the strike point when a light bullet that has been fired from said light gun hits a target; and
a competitor computer that is provided in a vicinity of a shooting box for shooting said light gun, that is connected to said strike point detection means by way of a communication network, and that is used by the competitors for proceeding with the competition; said electronic competition means being a means for adding up scores based on strike points of said light bullets when said light bullets are directed and fired at said targets by operation of said light guns.

12. An electronic competition system according to claim 11, wherein said competitor computer comprises a database client that can access data of said database management system.

13. An electronic competition system according to claim 11, wherein said competitor computer displays competition modes based on control of said server.

14. An electronic competition system according to claim 11, wherein said competitor computer displays time relating to a competition based on control by said server.

15. An electronic competition system according to claim 11, wherein said competitor computer is provided with a camera for acquiring images of said competitors.

16. An electronic competition system according to claim 11, wherein:
said competitor computer is provided with an identification information input means for receiving as input identification information of each of said competitors; and
said server is provided with an approval means for collating identification information that has been received from said competitor computer and identification information of competitors that have registered in advance and, when information matches, for approving a person that has entered said identification information to said identification information input means.

17. An electronic competition system according to claim 11, wherein said strike point detection means is provided with a camera for acquiring images of said competitors.

18. An electronic competition system according to claim 11, wherein said competitor computer and said strike point detection means are adjusted in accordance with competition levels.

19. An electronic competition system according to claim 1, further comprising a second server that can connect by way of an Internet to each of said servers that are established at each of a plurality of competition sites and that comprises an integrative database management system that, in synchronization with said database management systems, performs centralized management of the competition progress and competition results of each of said competitors that are managed by said database management systems of each of said servers.

20. An electronic competition system according to claim 11, further comprising a second server that can connect by way of an Internet to each of said servers that are established at each of a plurality of competition sites and that comprises an integrative database management system that, in synchronism with said database management systems, performs centralized management of the competition progress and competition results of each of said competitors that are managed by said database management system of each of said servers.

21. An electronic competition system according to claim 19, wherein said second server publishes on the Internet the competition progress and competition results that are under the centralized management of said integrative database management system.

22. An electronic competition system according to claim 19, wherein said second server publishes a web page for entrance registration on the Internet.

23. An electronic competition system according to claim 22, wherein said second server manages entrance registration of each competitor that has used said Web page to perform entrance registration.

24. An electronic competition system according to claim 23, wherein said second server publishes on the Internet information on each competitor that has carried out said entrance registration.

25. An electronic competition system according to claim 23, wherein said second server collects fees from each competitor that has carried out said entrance registration.

26. An electronic competition system according to claim 19, wherein said second server singles out finalists from among said competitors based on competition results that are managed by said integrative database management system.

27. An electronic competition system according to claim 26, wherein said second server publishes on the Internet information on each of said finalists.

28. An electronic competition system according to claim 27, wherein information on each of said finalists includes a picture of each of said finalists.

29. An electronic competition system according to claim 19, wherein said second server notifies predetermined transmission destinations that a competition is to be held.

30. An electronic competition system according to claim 29, wherein said notification that a competition is to be held contains information for accessing a site that is managed by said second server.

31. An electronic competition system according to claim 1 that further comprises a display means that can simultaneously display the competition progress of a plurality of competitors or the competition results of a plurality of competitors.

32. An electronic competition system according to claim 11 that further comprises a display means that can simultaneously display the competition progress of a plurality of competitors or the competition results of a plurality of competitors.

33. An electronic competition system according to claim 19 that further comprises a display means that can simultaneously display the competition progress of a plurality of competitors or the competition results of a plurality of competitors.

34. An electronic competition system according to claim 1, wherein said competition progress and competition results include a track of strike points.

35. An electronic competition system according to claim 11, wherein said competition progress and competition results include a track of strike points.

36. An electronic competition system according to claim 19, wherein said competition progress and competition results include a track of strike points.

37. An electronic competition method for holding an electronic competition in which a plurality of competitors compete, said electronic competition method comprising the steps of:
connecting an electronic competition means for outputting competition progress and competition results of each of said competitors to a server having a database management system by way of a communication network; and
using said database management system to successively accumulate, convert to a database, and manage each of said competition progress and competition results.

38. An electronic competition method according to claim 37, further comprising the step of using said server to publish on said communication network competition progress and competition results that are managed by said database management system.

39. An electronic competition method according to claim 37, further comprising the step of using said server to manage entrance registration of each of said competitors.

40. An electronic competition method according to claim 39, further comprising the step of using said server to publish on said communication network information on each competitor that has carried out said entrance registration.

41. An electronic competition method according to claim 37, further comprising the step of using said server to carry out scheduling of each of said competitors.

42. An electronic competition method according to claim 37, further comprising the step of using said server to manage the competition progress of each of said competitors.

43. An electronic competition method according to claim 37, further comprising the step of using said server to single out finalists from among said competitors based on competition results that are managed by said database management system.

44. An electronic competition method according to claim 43, further comprising the step of using said server to publish on said communication network information on each of said finalists.

45. An electronic competition method according to claim 44, wherein said information on each of said finalists includes pictures of said finalists.

46. An electronic competition method according to claim 37, wherein said electronic competition means is provided with a plurality of sets of:
a light gun for shooting light bullets;
a strike point detection means for detecting the strike point when a light bullet that has been fired from said light gun hits a target; and
a competitor computer that is provided in a vicinity of a shooting box for shooting said light gun, that is connected to said strike point detection means by way of a communication network, and that is used by the competitors for proceeding with the competition;
said electronic competition means being a means for adding up scores based on strike points of said light bullets when said light bullets are directed and fired at said targets by operation of said light guns.

47. An electronic competition method according to claim 46, wherein said competitor computer comprises a database client that can access data of said database management system.

48. An electronic competition method according to claim 46, further comprising the step of using said competitor computer to display competition modes based on control of said server.

49. An electronic competition method according to claim 46, further comprising the step of using said competitor computer to display time relating to a competition based on control by said server.

50. An electronic competition method according to claim 46, wherein said competitor computer is provided with a camera for acquiring images of said competitors.

51. An electronic competition method according to claim 46, further comprising the steps of:
collating identification information of each of said competitors that has been received as input from said competitor computer and identification information of each of said competitors that has been registered in advance; and
approving an identity of a person who has entered said identification information, when a match occurs.

52. An electronic competition method according to claim 46, wherein said strike point detection means is provided with a camera for acquiring images of said competitors.

53. An electronic competition method according to claim 46, further comprising the step of adjusting said competitor computer and said strike point detection means in accordance with competition levels.

54. An electronic competition method according to claim 37, further comprising the steps of:
providing a second server that can connect by way of an Internet to each of said servers that are established at each of a plurality of competition sites and that comprises an integrative database management system that is synchronized to said database management systems; and
using said integrative database management system to perform centralized management of the competition progress and competition results of each of said competitors that are managed by said database management systems of each of said servers in synchronization with said database management systems.

55. An electronic competition method according to claim 46, further comprising the steps of:
providing a second server that can connect by way of an Internet to each of said servers that are established at each of a plurality of competition sites and that comprises an integrative database management system that is synchronized to said database management systems; and
using said integrative database management system to perform centralized management of the competition progress and competition results of each of said competitors that are managed by said database management systems of each of said servers in synchronization with said database management systems.

56. An electronic competition method for holding an electronic competition in which a plurality of competitors compete at a plurality of competition sites, said electronic competition method comprising the steps of:
outputting competition progress and competition results of each of said competitors from electronic competition means that are established in each of said plurality of competition sites;
receiving, by way of a communication network, said competition progress and competition results of each of said competitors that have been outputted from said electronic competition means by means of server that are established at each of said plurality of competition sites and that each comprise a database management system;
using said database management systems to successively accumulate, convert to a database, and manage said competition progress and competition results of each of said competitors that have been received by said servers and to transmit to a second server that can connect to said servers by way of an Internet and that comprises an integrative database management system; and
using said integrative database management system to implement centralized management of said competition progress and competition results that have been transmitted to said second server in synchronization with said database management systems.

57. An electronic competition method according to claim 54, further comprising the step of using said second server to publish on the Internet the competition progress and competition results that are under the centralized management of said integrative database management system.

58. An electronic competition method according to claim 56, further comprising the step of using said second server to publish on the Internet the competition progress and competition results that are under the centralized management of said integrative database management system.

59. An electronic competition method according to claim 54, further comprising the step of using said second server to publish a Web page for entrance registration on the Internet.

60. An electronic competition method according to claim 56, further comprising the step of using said second server to publish a Web page for entrance registration on the Internet.

61. An electronic competition method according to claim 59, further comprising the step of using said second server to manage entrance registration of each competitor that has used said Web page to perform entrance registration.

62. An electronic competition method according to claim 61, further comprising the step of using said second server to publish on the Internet information on each competitor that has carried out said entrance registration.

63. An electronic competition method according to claim 61, further comprising the step of using said second server to collect fees from each competitor that has carried out said entrance registration.

64. An electronic competition method according to claim 54, further comprising the step of using said second server to single out finalists from among said competitors based on competition results that are managed by said integrative database management system.

65. An electronic competition method according to claim 56, further comprising the step of using said second server to single out finalists from among said competitors based on competition results that are managed by said integrative database management system.

66. An electronic competition method according to claim 64, further comprising the step of using said second server to publishes on the Internet information on each of said finalists.

67. An electronic competition method according to claim 66, wherein information on each of said finalists includes a picture of each of said finalists.

68. An electronic competition method according to claim 54, wherein said second server notifies predetermined transmission destinations that a competition is to be held.

69. An electronic competition method according to claim 56, wherein said second server notifies predetermined transmission destinations that a competition is to be held.

70. An electronic competition method according to claim 68, wherein said notification that a competition is to be held contains information for accessing a site that is managed by said second server.

71. An electronic competition method according to claim 37, further comprising the step of using a display means to simultaneously display the competition progress of a plurality of competitors and the competition results of a plurality of competitors.

72. An electronic competition method according to claim 46, further comprising the step of using a display means to simultaneously display the competition progress of a plurality of competitors and the competition results of a plurality of competitors.

73. An electronic competition method according to claim 56, further comprising the step of using a display means to simultaneously display the competition progress of a plurality of competitors and the competition results of a plurality of competitors.

74. An electronic competition method according to claim 37, wherein said competition progress and competition results include a track of strike points.

75. An electronic competition method according to claim 46, wherein said competition progress and competition results include a track of strike points.

76. An electronic competition method according to claim 56, wherein said competition progress and competition results include a track of strike points.

77. A server that is connected by way of a communication network to an electronic competition means for holding an electronic competition in which a plurality of competitors compete, said server comprising a database management system for successively accumulating, converting to a database, and managing competition progress and competition results of each of said competitors.

78. A server according to claim 77, wherein said server publishes on said communication network competition progress and competition results that are managed by said database management system.

79. A server according to claim 77, wherein said server manages entrance registration of each of said competitors.

80. A server according to claim 79, wherein said server publishes on said communication network information on each competitor that has carried out said entrance registration.

81. A server according to claim 77, wherein said server carries out scheduling of each of said competitors.

82. A server according to claim 77, wherein said server manages the competition progress of each of said competitors.

83. A server according to 77, wherein said server singles out finalists from among said competitors based on competition results that are managed by said database management system.

84. A server according to claim 83, wherein said server publishes on said communication network information on each of said finalists.

85. A server according to claim 84, wherein said information on each of said finalists includes pictures of said finalists.

86. A server according to claim 77, wherein identification information of each of said competitors that is received as input from said electronic competition means and identification information of each of said competitors that has been registered in advance are collated, and when information matches, an identity of said competitor is approved.

87. A second server that can connect by way of an Internet to a server according to claim 77 that is established at each of a plurality of competition sites, and that comprises an integrative database management system for, in synchronization with said database management systems, implementing centralized management of said competition progress and competition results of each of said competitors that are managed by the database management systems of each of said servers.

88. A second server according to claim 87, wherein said second server publishes on the Internet the competition progress and competition results that are under the centralized management of said integrative database management system.

89. A second server according to claim 87, wherein said second server publishes a Web page for entrance registration on the Internet.

90. A second server according to claim 89, wherein said second server manages entrance registration of each competitor that has used said Web page to perform entrance registration.

91. A second server according to claim 90, wherein said second server publishes on the Internet information on each competitor that has carried out said entrance registration.

92. A second server according to claim 90, wherein said second server collects fees from each competitor that has carried out said entrance registration.

93. A second server according to claim 87, wherein said second server singles out finalists from among said competitors based on competition results that are managed by said integrative database management system.

94. A second server according to claim 93, wherein said second server publishes on the Internet information on each of said finalists.

95. A second server according to claim 94, wherein information on each of said finalists includes a picture of each of said finalists.

96. A second server according to claim 87, wherein said second server notifies predetermined transmission destinations that a competition is to be held.

97. A second server according to claim 96, wherein said notification that a competition is to be held contains information for accessing a site that is managed by said second server.

98. A server having a program for causing a computer, said computer being connected by way of a communication network to an electronic competition means for holding an electronic competition in which a plurality of competitors compete, to execute a processing of a database management system for successively accumulating, converting to a database, and managing competition progress and competition results of each of said competitors.

99. A server having a program according to claim 98 for causing said computer to execute processing for publishing on said communication network said competition progress and competition results that are managed by said database management system.

100. A server having a program according to claim 98 for causing said computer to execute processing for managing entrance registration of each of said competitors.

101. A server having a program according to claim 100 for causing said computer to execute processing for publishing on said communication network information on each competitor that has carried out said entrance registration.

102. A server having a program according to claim 98 for causing said computer to execute processing for scheduling each of said competitors.

103. A server having a program according to claim 98 for causing said computer to execute processing for managing the competition progress of each of said competitors.

104. A server having a program according to claim 98 for causing said computer to execute processing for singling out finalists from among said competitors based on competition results that are managed by said database management system.

105. A server having a program according to claim 104 for causing said computer to execute processing for publishing on said communication network information on each of said finalists.

106. A server having a program according to claim 105, wherein said information on each of said finalists includes pictures of said finalists.

107. A server having a program according to claim 98, wherein identification information of each of said competitors that has been received as input from said electronic competition means and identification information that has been registered in advance are collated, and when the information matches, an identity of said competitor is approved.

108. A second server having a program for causing a second computer, said second computer being capable of connecting by way of an Internet to each of said computers of servers according to claim 98 that are established at a plurality of competition sites, to execute processing of an integrative database management system for implementing centralized management of said competition progress and competition results of each of said competitors that are managed by the database management system of each of said computers of servers in synchronization with said database management systems.

109. A second server having a program according to claim 108 for causing said second computer to execute processing for publishing on the Internet the competition progress or competition results that are under the centralized management of said integrative database management system.

110. A second server having a program according to claim 108 for causing said second computer to execute processing for publishing a Web page for entrance registration on the Internet.

111. A second server having a program according to claim 110 for causing said second computer to execute processing for managing entrance registration of each competitor that has used said Web page to perform entrance registration.

112. A second server having a program according to claim 111 for causing said second computer to execute processing for publishing on the Internet information on each competitor that has carried out said entrance registration.

113. A second server having a program according to claim 111 for causing said second computer to execute processing for collecting fees from each competitor that has carried out said entrance registration.

114. A second server having a program according to claim 108 for causing said second computer to execute processing for singling out finalists from among said competitors based on competition results that are managed by said integrative database management system.

115. A second server having a program according to claim 114 for causing said second computer to execute processing for publishing on the Internet information on each of said finalists.

116. A second server having a program according to claim 115, wherein said information on each of said finalists includes a picture of each of said finalists.

117. A second server having a program according to claim 108 for causing said second computer to execute processing for notifying predetermined transmission destinations that a competition is to be held.

118. A second server having a program according to claim 117, wherein said notification that a competition is to be held contains information for accessing a site that is managed by said second server.
